(19) United States
(12) Patent Application Publication
(10) Pub. No.: US 2014/0188851 A1
(43) Pub. Date: Jul. 3, 2014

(54) Social Media Platform for Sharing Entity Type and or Product Type and or Prospective Event Type Internet Related Data

(71) Applicant: Paula Natasha Chavez, Narrabundah (AU)

(72) Inventor: Paula Natasha Chavez, Narrabundah (AU)

(21) Appl. No.: 14/145,925

(22) Filed: Dec. 31, 2013

Related U.S. Application Data
(60) Provisional application No. 61/748,064, filed on Dec. 31, 2012.
(60) Provisional application No. 61/748,452, filed on Jan. 3, 2013.
(60) Provisional application No. 61/752,988, filed on Jan. 16, 2013.
(60) Provisional application No. 61/814,274, filed on Apr. 21, 2013.

(51) Int. Cl. G06F 17/30

(52) U.S. Cl. CPC G06F 17/3087
USPC 707/722

(57) ABSTRACT

Disclosed is a method and user interface for receiving and delivering Internet-related data. The method includes receiving identifying information that is correlated to one or more user profiles, receiving Internet-related data into a database, the data received via the input associated with one or more user profiles, wherein at least one data attribute is geographical location data and another attribute is entity type and/or product type and/or event type data and receiving a user notification that a device is capable of receiving geographic location data and entity type and/or product type and/or event type data. The method further includes determining that the Internet-related data is prospective to generate matching data that is prospective, delivering matching data output and making available, if available, a representation of the input associated with one or more user profiles from which the Internet-related data is derived so that it is reconcilable on a user interface.

### RELATED APPLICATIONS

This patent application derives its priority from U.S. provisional applications 61/748,064, 61/748,452, 61/752,988, and 61/814,274.

### FIELD OF THE INVENTION

The invention relates to a social media platform for sharing Internet-related data that pertains to Entity Type and/or Product Type and/or Prospective Event Type data so that users can learn about topics that interest them as they pertain to geographical locations.

### BACKGROUND OF THE INVENTION

Searching for information on the Internet is hampered by the sheer number of websites and Internet postings. While search engines solve many problems of parsing through Internet-based information, their solutions provide new problems in an average Internet surfer's quest for information. For example, the ranking systems of search engines promotes certain websites while others that may be of interest are buried in pages of non-relevant postings. Without the proper search terms, gems are missed. For example, some small entities have a limited web presence. A small winery, or a mom and pop restaurant on a quiet country road may have a single page website. How would someone planning a trip in their region find them without knowing of them in advance? The answer is by sheer chance. There are a substantial number of social media platforms. However, few or none of them provide a way to share with like-minded others discoveries of both online and offline information and experiences. Social media to date is largely unordered. Platforms such as Pinterest and Stumble Upon take a throw it at the wall and see what sticks approach. Such platforms are good for users to pass time perusing however, they offer little in the way of the ability to access sought after information. Search engines and social media platforms lack the ability to seek out and find useful order in the Internet while connecting with like-minded users.

The present invention can be used to provide and learn information relating to virtually any topic. For example, the travel topic is obviously an enormous one. There are many big players in the field. However, there are many more small players. While most of these small players have a web presence, they are largely only found by chance since their web presence does cannot compete on search engines. The present disclosure including the disclosure incorporated by reference provides a manner in which their chance of discovery by the public at large is substantially increased. A substantial number of small players have e-commerce capability. That number is of course growing, however, business is still hampered by the volume of commercial entities having a web presence.

As mentioned, travel is an enormous topic. The travel industry expects one billion travellers in 2013. Venue related entertainment is also a huge industry. In Australia alone, having a population of 22 million, a national study of the value of live music has found that in 2009/10 the Australian live music industry injected $1.21 billion into the national economy, with total profits and wages of $652 million and supporting almost 15,000 full-time jobs. The outcomes of this study were released in a report by Ernst & Young called, “The economic contribution of the venue-based live music industry in Australia”. The study examined the value of live music from a venue's perspective and the figures demonstrate the industry's significant contribution to the Australian economy. The industry also attracts strong audiences with the report finding that 41.97 million patrons attended 328,000 venue-based live music performances at 3,904 venues across Australia in 2009/10.

Huge masses of people pass through popular travel destinations. For example, 10,000 to 30,000 visitors walk through the Sistine Chapel every day, coming from all of the corners of the globe. Before and after their visit, these like-minded individuals go on their way, never knowing if their paths will cross again. Some of these visitors are on tours, and so they are making connections with their tour mates. But for the most part, people will come and go, and have no way to know if they have other interests in common. For example, two strangers whose paths may cross may have interests in travel to ancient sights and destinations, physics, jewellery arts, are atheists and are politically liberal. Their paths may cross at the Sistine Chapel, or for that matter, at a Neil Young show in Sydney, but they have no way to know it.

The Internet has provided opportunities for new businesses. Currently, there is a vast spectrum of manners in which businesses use the Internet. For example, retailers not having store fronts and that strictly engage in e-commerce are pervasive. However, at the same time, so called, bricks and mortar businesses still exist. Many bricks and mortar businesses also have a web presence, as well as e-commerce. There can be a symbiotic relationship with the two marketing arms of their businesses. Because they are bricks and mortar, they are able to drive traffic to their on-line website by virtue of their street presence. They have a reputation in the local community which promotes their online businesses.

Many brick and mortar businesses do have at least a small website which is, for example, printed on their business card. Even though they know that their web presence will not be easily found by searching via search engines, they can continue their businesses in traditional manners. In the case, for example, of antique dealers, their inventory can be so varied, inventory management may be overwhelming for them to photograph each item, provide a description, etc., to build an e-commerce business within their bricks and mortar businesses. They may utilize auction websites such as eBay which can provide links to their own websites, but building their own e-commerce may be difficult.

For other types of businesses, other Internet entities such as www.esty.com can provide e-commerce capability. Etsy has attracted about 875,000 active sellers and 15 million members. Etsy has a business model where as an Etsy shop owner, as active seller can list items which can be purchased through the Etsy e-commerce capability. The model includes Etsy of course receiving a fee for the sale, as does PayPal or other financial engines—but at the same time providing a valuable service for countless businesses that do not have their own e-commerce capability. Businesses fitting into the Etsy shop criteria, on their own website provide a link to Etsy to promote e-commerce.

On the other hand, there are bricks and mortar businesses that still do not have a web presence and therefore do not have e-commerce. Local yellow page type enterprises may list their street presence. Oftentimes, simply listing their address to those who know their trade name suffices for the time being. While the prospect of a web presence on the Internet is not unknown to them, they may be making a comfortable living from their street presence, and/or may be put off by the complications of a website and/or of e-commerce. For example, they may be aware that the chances of their being found by a user not already knowing their trade name on a search engine are remote. Therefore, having an actual web presence may not seem worth the trouble.

When travellers go to their travel destinations, they often find the easy to find places of interest and accommodations due to travel books and travel websites, access to which is easily available. For example, the antique shops located on the well-known shopping district streets are easy to find, and tourists will support these establishments. Flyers, pamphlets and other marketing materials are pervasive in the travel industry to entice travellers to take up their offerings. Hotels employ a concierge to help travellers enjoy their stay. B and B's are often preferable to travellers since the owners of the B and B's are locals and can give travellers good advice on the area.

For the locals there may be other districts in a town that have shops such as antique shops that are not near the well-known shopping districts. If a traveller does not have access to local information because they are just passing through, or their local sources are not good enough, they may not find the enterprises that by default cater to locals. It is not that the owners of these local businesses would not like to be found by travellers, such as those seeking antique shops, it is that the business model of those particular shops, among other possible reasons, will not allow them to rent space on high-rent shopping district streets. There are other aspects of local life that will not easily be found by travellers. For example, exhibitions or events such as a “collectables fair” and the like, will not be easy to find by travellers. Locals who read local newspapers or see signs posted where they were not there before, may be more likely to find these events and exhibitions, as well as they will come to expect them, year after year.

A vendor who has a temporary presence and cannot claim a street presence such as a bricks and mortar business, such as one who has a stand at a weekly market will often not be discovered by travellers. The market may be known to travellers as it may be in travel guides, and the market may even have a website including lists of the vendors, but only a trip to the market will allow a traveller to stumble upon a weekly vendor who catches their eye at a market. There is certainly little possibility that such vendors will be found by a search engine while looking for local attractions.

Many travellers wish that their travel experiences to allow them to live like the locals. This type of traveller may rent a vacation rental such as an apartment or house in a particular region of interest. Oftentimes, the owners of the vacation rental will leave a booklet of establishments and activities that the traveller may find enjoyable. The traveller may look to the rental owner's booklet as advise on the owner's favourites since the owner of the vacation rental may in fact, and most often is, a local. However, until the traveller arrives as the vacation rental, they may not be able to learn much about living like a local.

Some other local things are currently difficult to find out, in particular entertainment. For example, a traveller may not know what entertainment attractions will be going on during their stay since there is currently no central or global source for local information. Travellers from Oklahoma and from Sydney may be planning to visit France, and in particular, the Languedoc-Roussillon region. There is currently no way for these travellers to find out truly local information about Languedoc-Roussillon before they arrive at the destination. For example, tours of performance artists passing through a region of interest may not be evident from utilizing search engines unless the user is following particular performance artists. In this way, they may miss out on opportunities to purchase tickets for events that they would have liked to attend and enjoy with the locals.

An engine in the background operates to make a user's favourites shareable and searchable. That is, if the user's favourite can be found on the Internet, a link to the favourite can be added to a page correlated with a user profile. The page can be topic-based or can include an unordered collection of topics. Preferably, pages are topic based so that when another user accesses them in the context of social media, the pages are representative of certain interests and passions. Topics can be user defined and/or selected. Once the user posts a favourite on their page, the engine will process it in different ways so that the favourite can be delivered to other users.

The Social Media aspect of the engine is the ability to connect with other users who share passions. Since users add their favourites to the system, the need for SEO by entities is not present. The fields of use are numerous. The initial target market is global local information. Revenue can be generated by sponsorship, e-commerce tie-ins, and promotion of web presence. Competition is social media sites such as Pinterest and Yelp, however, the differences are substantial. The competitive advantage is the topic based searching capability that provides the information that the user actually seeks based upon the engine's ability to sort and appropriately deliver the users' favourites posted.

A global local information resource including local events would provide to locals and travellers alike the opportunity to better enjoy what a region has to offer. For example, while locals may know what are the good dance spots in Sydney, Australia, doing a Google search for dance clubs renders little in the way of finding locals' favourites. Many of the postings are out of date and not very helpful so a traveller can only find out what is really going on by asking a local bartender.

### SUMMARY

Disclosed is a system and a user interface method of a social media platform system that provides the ability to access content in the form of links on a topic board (FavePage) and to make corresponding content available within the system and/or outside the system. As described below a topic board can be built, constructed, uploaded or otherwise accessible to a user who has access to the system. An entity can be commercial, not-for-profit, government, or any other type of entity. A product can be physical, intellectual, media or any other type of product. A prospective event is an event that will happen or is happening. Past events are relevant if they relate to a prospective event.

A user who seeks information that is accessible in the system can access a plurality of topic terms that are correlated with rating criteria within the system and indicate a plurality of topic terms so that one or more topic terms may be selected by a user. A user may add topic terms that can be searched as well. The topic terms may have corresponding rating information indicated to the user, for example, providing the number of occurrences of the topic term the correlate to a specific geographical region. In a perfect situation, many entities would be represented on the system, on many boards. As an example, for the region of Canberra or the larger ACT, and/or the surrounding New South Wales area a local's board may include ten links to ten websites of local businesses.

Best practices would lead a user having a profile who constructs a board to limit the types of entities that they put on a board. That is why it is useful to allow a user having a profile to construct as many boards as they wish. For example, were a user to put 1 or 2 types of entities on their board, their board may be rated to the top of a topic search as most useful to a user. Moreover, if that board with 1 or 2 types of entities on that board had met a threshold of link entries compared to other entries found during the search, then that board may be rated at the top of a topic search.

For example, the author's faves would be the Old Bus Depot Market (markets), PNC Metalsmith Jewellery (jewellery store (at a market)), Bijoux (jewellery store (in a shopping district)), David Loong (jewellery store (at a market)), Japonicity (jewellery (store at a market)). (It should be noted that jewellery stores, at the time of this disclosure, come up in a “Google Search” of “jewellery stores Canberra” are those of paid advertisers but do not include stalls at the Old Bus Depot Market). The topic tags are therefore:

### Markets

Jewellery Stores which is a Sub-Category of Fashion

In the system, for Canberra, there may be one hundred (100) boards with the broad topic categories of fashion, fifty (50) boards having jewellery shops, and eighty (80) local products markets. The possibility that there would be so many as eighty (80) with markets is that markets are a very broad category, even though there may be only eight of them in town, many locals may list the same entity. There is the possibility that tags may be misused, for example, a user may list markets as a topic tag, when they really mean festivals such a yearly school fete or yearly event such as Floriade in Canberra. In this way, it is useful to include date filters to present pertinent information to the searching user.

A searching user searches in the region of Canberra for fashion and jewellery shops, that user will find the author's board of Canberra's favourites, including four jewellery shops, the links to which may be highlighted and/or ordered to the top, but then other favourites will be found as well, including the market, the Old Bus Depot Market. The searching user may decide to access the links of the other favourites, or not, but in any event, they now know this Canberran's favourites. They may collect the favourites, for example, by clicking and dragging them to their own visitor's board for later reference.

It should be noted that while a board can include links to the user's favourite entities, if there is an entity link that is only listed as for example, a yellow page listing, this will probably not be very interesting to a searching user. Therefore, there is an opportunity of the present invention to motivate entities whose links are presented to obtain at least a small web presence. This motivation presents a business opportunity for the system, as well as the sponsorship opportunities previously mentioned. A service of the system may be to provide web site or web page development to give small operators a web presence. If they are on the boards without a distinct website domain address, but are listed as Etsy or the Yellow Pages, the system may contact them, tell them that they have been listed on a page but their chances of being discovered are limited by their web presence and offering (no pictures are provided in a Yellow Pages link). In this way, upon a determination that the link is not directed to a distinct domain website, but to an entity such as Etsy, or the Yellow Pages, again there is an opportunity to motivate the entity to obtain at least as small web presence.

Another of the present author's faves, David Loong, has a website that directs his e-commerce to Etsy, but he does sell one time a month at the Old Bus Depot Market, and he does list his next market days on his website. David Loong has all of the attributes of the system that would make finding him within the system by a searching user a benefit to the user, extending the enjoyment of the Canberra region and a benefit to the entity. For example, were a traveller to visit Canberra, and the Old Bus Depot Market and stumble upon David Loong's stall at the Old Bus Depot Market, but could not really remember where they saw the work, but just wanted to find the work they saw in Canberra again, they would most likely turn to the FAVE of Faye Pages over a search engine to find the small vendor.

Another benefit about the way the FAVE/Fave Pages works, is that businesses of like kinds often find each other and locate together in geographical areas. For example, several antique shops that cater to locals might be found on the same street in a town. Nightclubs congregate too, as do furniture stores. In this way, were a board building user to limit the number of topics on each of their boards, to say fashion and jewellery, it would have a similar result to the locations of bricks and mortar businesses.

If when the searching user comes across too many pages when searching for jewellery stores in their search, they can limit their search results by adding in another topic such as glass. In this way, only boards that have both glass and jewellery stores will be found in their search results.

The mobile capture of the positive data is disclosed. There are different manners in which to capture the positive data, depending upon the availability of technology and the circumstances. The systems and methods described herein provide a mobile device user many manners in which to add positive data to the system.

### BRIEF DESCRIPTION OF THE DRAWINGS

FIG. 1 illustrates Building Bulletin Boards and Notification Aspects of this Invention;

FIG. 2 illustrates Processing Areas of Interest;

FIG. 3 illustrates Issues of Hierarchy;

FIG. 4 illustrates that the system has the ability to connect users based on their transactions;

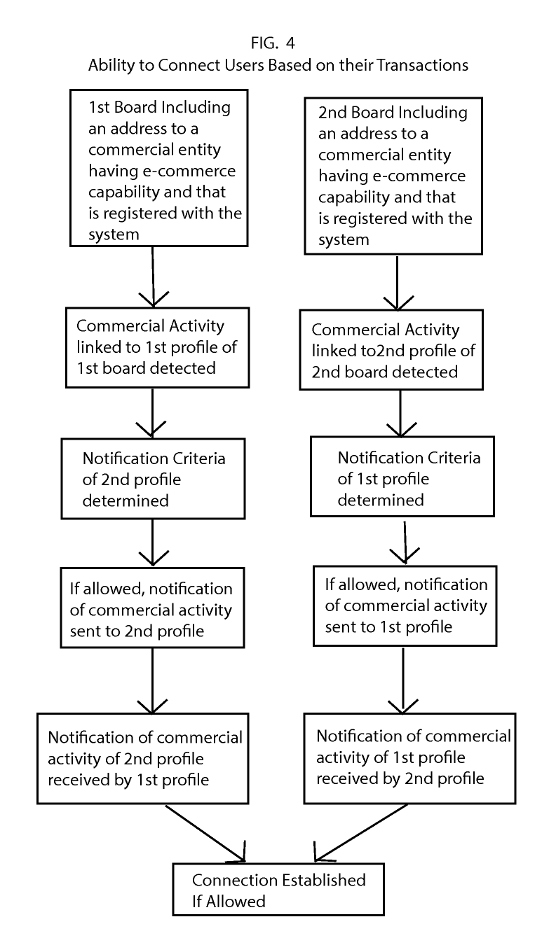

FIG. 5 illustrates that the system has the ability to provide itinerary boards which can be populated with data retrieved from any number of boards, and then connect users based common elements of their itineraries;

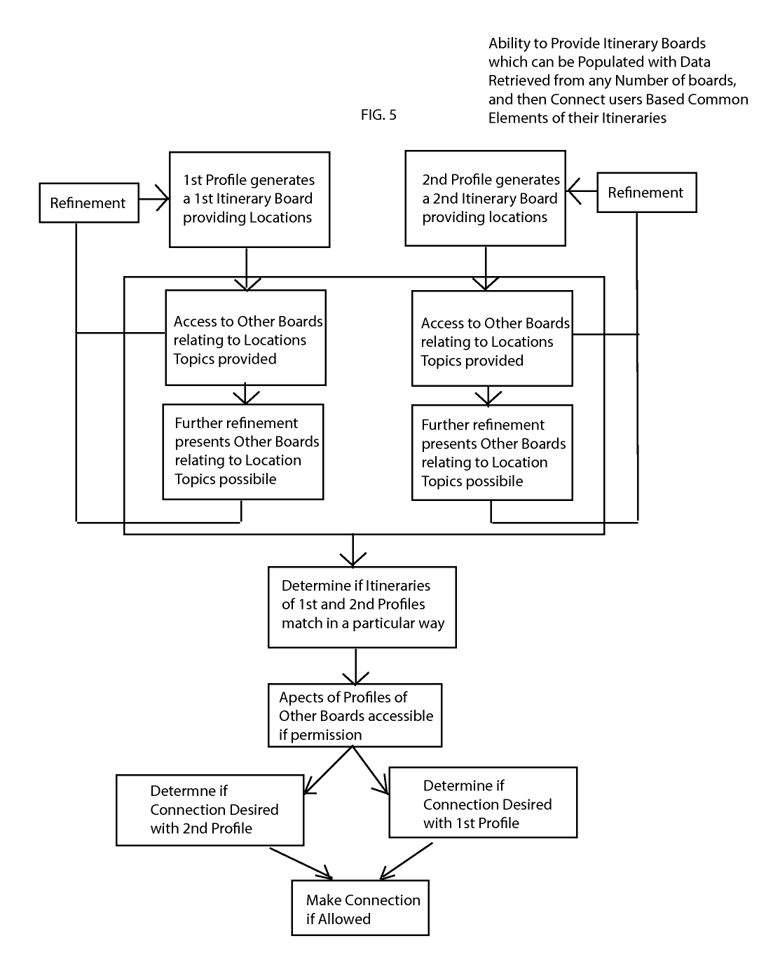

FIG. 6 illustrates a map of the world with a finger selecting a region of the world, in this case Europe;

FIG. 7 illustrates a topic page listing the region selected in FIG. 6, Europe as well as subregions, Eastern, Southern, Western and Northern and the countries in each of these. France has been selected. The topic listing page of this FIG. 7 could have been provided in a map form in a similar way as FIGS. 6 and 8;

FIG. 8 illustrates a map of France with a finger selecting a region of France, in this case Languedoc-Roussillon;

FIG. 9 illustrates a topic page listing of the Languedoc-Roussillon region including a break-down of different region characteristics that may assist a traveller determine an itinerary, where it is understood that all sovereign states have region characteristics that can be broken down in different ways and that this depiction of the manner France is broken down does not limit the scope of the invention;

FIG. 10 depicts alphabetical topic lists of items that may be of interest to a traveller looking for local information where it is understood that this list depiction is an example of what a list may look like for the Languedoc-Roussillon region of France, and that all sovereign states have regional characteristics that may lend themselves to different categorizations and sub-categorizations;

FIG. 11 depicts an embodiment of the manner in which a board can be constructed by a user adding to the system. For example, a builder may start with respect to the region selected via the topic listing page of FIG. 9, and then move to FIG. 10, where the clicking on “local products” may present categories and subcategories, where further indicating by clicking or highlighting or any other suitable manner, may present the topics including categories and subcategories, with distinction or not between them. Finally the board/fave page is presented and the user imports links to the board and the system crunches the data including counting occurrences of topic tags and links.

FIG. 12 depicts an embodiment of the manner in which a user can search the system. Referring to FIG. 9 where Languedoc-Roussillon is selected, a user may make selections for musical performances, entertainment, walled cites, amphitheatres, and nightlife, the lists similar to those found on FIG. 10;

FIG. 13 depicts an embodiment of the manner in which a user can search the system based on the selected topic tags of FIG. 12 and find boards/fave pages of other users and have the potential to connect with those users. In the case of entertainment in particular, a date filter may be useful. However, when a link to an attraction or a festival is presented, then it may be beneficial to determine if the information presented is reloaded so that old information is not cached;

FIG. 14 depicts an embodiment of the manner in which a board can be constructed by a user adding to the system in which general topics are presented. In this case, where a user is a jewellery enthusiast, in a manner similar to that of FIG. 13, can construct a board/fave page;

FIG. 15 depicts an embodiment of the manner in which a user can search the system based on the selected tags of FIG. 14 and find boards/fave pages of other users and have the potential to connect with those users.

FIG. 16 depicts a mobile device capturing a signal or an image of printed media that includes an Internet address of an entity;

FIG. 17 depicts a process by which an Internet address can be processed by the application and/or the engine; and

FIG. 18 depicts a process by which an image of an entity captured by a mobile device can be correlated with the Internet address of the entity and added to a page associated with a user profile.

### DETAILED DESCRIPTION

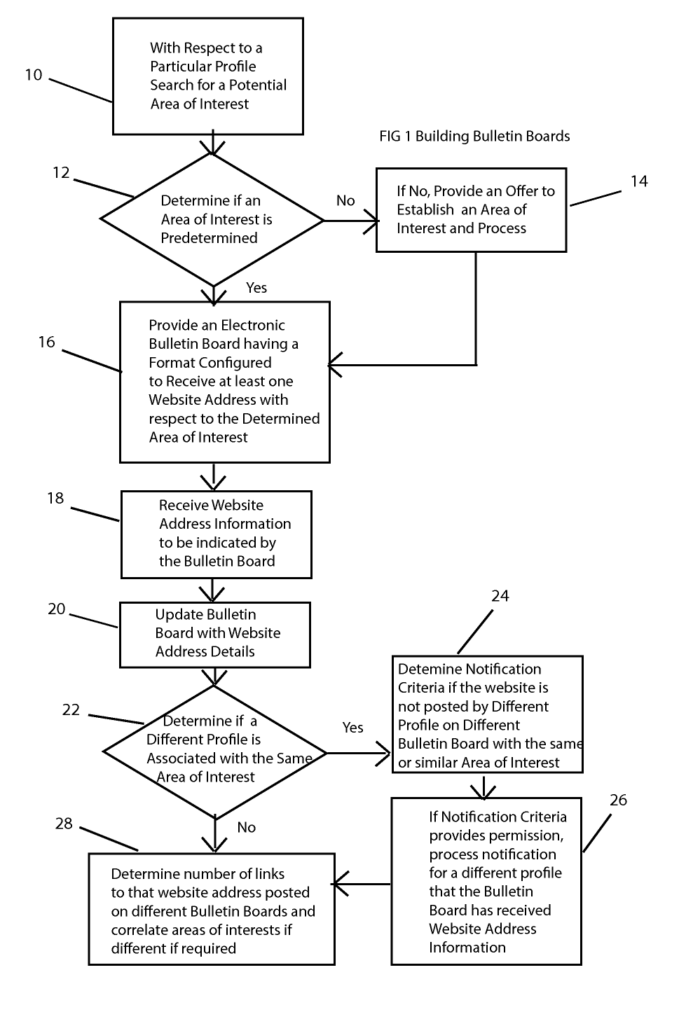

Referring to FIG. 1, a method and/or system of the present inventive social media platform system includes with respect to a particular profile of a user that may be anonymous or identified, determining a topic by indicating a predetermined topic list and a search capability to generate a determined topic 10. The topic can be user determined with various methods of identifying a topic including folksonomy 12. The topic can be narrowed in any manner, for example according to drop down menus, and/or searching, and the number of boards of favourite or pertinent Internet addresses relating to a particular topic can be indicated 14. Topic organization can be accomplished in any number of ways. In this way, a determination can be made if future narrowing of the topic is warranted. Also, in this way, the user having a profile may develop a personalized thread of topics. If a new search term via the search capability is received that is new to the system, provide a query to determine if the new search term may be added to the system and if so hierarchically correlate the new search term to a predetermined topic if possible. A new thread of topics can be developed in any number of ways and according to any number of different logic models.

Having settled upon a determined topic, either finally or temporarily, a user having a profile is provided an electronic bulletin board of sorts to post one or more particular Internet addresses to generate a posted Internet address associated with the electronic bulletin board 16. The address may be provided in any manner 18. The path to which the Internet address leads is not relevant. It can be to a commercial enterprise website, an informational webpage, or a Facebook page, or any other web place imaginable. For example, the link may be a favourites page on www.etsy.com. The electronic bulletin board will have a board tag consistent with the determined topic and an association with the particular profile 20.

A social media aspect of the platform is that there is a determination whether a different profile is associated with the determined topic or a topic that is within a hierarchical structure relatively closely comprising the determined topic 22, and if so, there is also determination if the particular Internet address has been associated with the different profile, and if not, there is a further determination of a notification criteria of the different profile, and if the notification criteria provides permission, a notification is processed relating to the different profile of the posted Internet address 24. In this way, a user with a different profile, but having the same or a similar interest can be, if so desired, notified of a new favourite or pertinent Internet website or posting 26. There is the possibility for any number of different filters to be applied, including blocking porn, bomb making information, etc., as well as blocking notifications as a user sees fit. Serious users can ultimately determine other serious users by the quality of the Internet addresses posted to particular boards and make ultimately connections 28. A difference between this inventive social media platform and say Facebook, is that the board is under the control of a user having a profile. Others may of course link to that board, but postings are posted by the user, be it an individual, a group or an entity. Any number of add-ons is possible including comments sections, blogs, uploaded photos, but they may be in the form of a link on the board to maintain coherence. It a may be decided that a board needs to be revised or broken up into smaller boards, and functionality to perform maintenance of boards and revising and/or changing topics is contemplated.

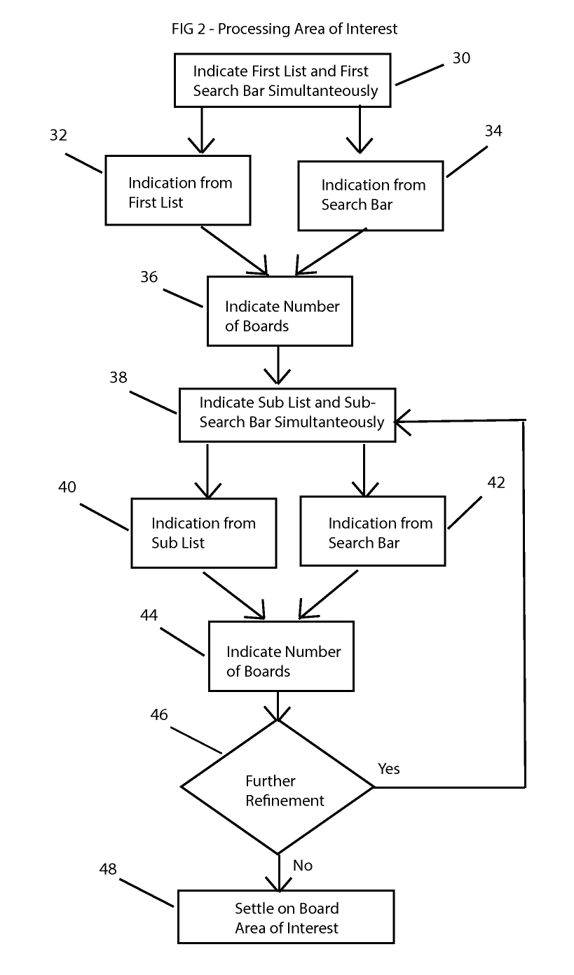

Referring to FIG. 2, as mentioned, the topics of a “FavePage” or topic board can be user defined. The user interface can provide the opportunity by providing lists, or filling in the details as a user types a topic title or not 30. Either way 32 and/or 34, a topic is generated. The term board used herein is like a bulletin board. However, as the development of these ideas has progressed, the term has become FavePage. They are meant as the same. When a user determines a topic and/or sub-topic and/or a plurality of either, there can be an indication of the number of FavePages that are already in existence on the system that include those topics as it may be interesting for the user to know that. Also, an indication of geographical location of the content of the topics would be interesting to know, and the indication 36 can be narrowed by location or other criteria. In the event that the indication was not as expected, or another search is desired, the user can narrow the list 38, and similarly process the sub-list 40 and 42, and indicate the number of FavePages 44. Further refinement is possible 46 until the topic is settled upon 48. The system will learn from experience how users define topics so that at least some of these steps can be automated to make the user experience better.

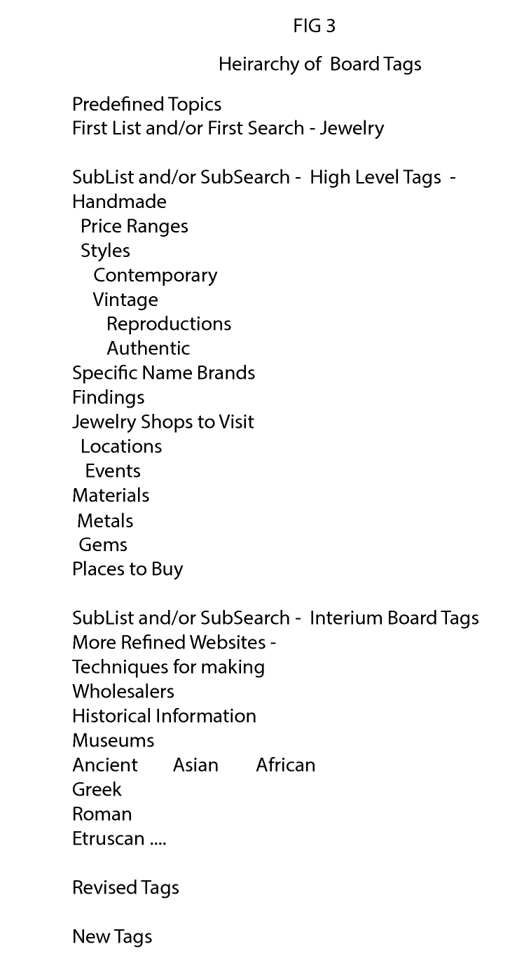

Referring to FIG. 3, just in the topic of jewellery, there are so many different facets that can be considered. A user may be profiled to suggest topics instead of relying on the user to define them. For example, if a user has a FavePage that consists of fine shoe shops in different locations, they may be more interested in gold/silver/gems jewellery and not in fashion jewellery. Suggestions can be made to the user for the topics and subtopics based on previous preferences and profiling.

The method and user interface for receiving and delivering Internet-related data therefore includes receiving identifying information that is correlated to one or more user profiles so that the user can set up a FavePage onto which the system can receive Internet-related data into a database, the data characterised by attributes, the data received via the input associated with one or more user profiles, wherein at least one attribute is geographical location data and another attribute is entity type and/or product type and/or event type data so that they system can receive a user notification that a device is capable of receiving geographic location data and entity type and/or product type and/or event type data. The device can be any type of communication device that communicate via the World Wide Web. The system may correlate the attributes of the Internet-related data with a user profile and determine that the Internet-related data is prospective to generate matching data that is prospective, the matching data being defined by prospective characteristics. As mention there are different manners to determine the prospective nature of the data prior to delivering it to a user via a device having a user interface. For example, websites visited via the user interface may not be cached to make sure they are the most updated version. Dates can be checked with date filters and/or by manual intervention. The system can deliver matching data output that is reconcilable on a user interface to indicate the geographical location data with respect to the entity type and/or product type and/or event type data with prospective characteristics. Because it would be of interest to learn more about shared interests, the system may make available, if available, a representation of the input associated with one or more user profiles from which the Internet-related data is derived taking into account prospective characteristics so that it is reconcilable on a user interface.

One manner in which a revenue stream can be created can be by enlisting sponsors. The platform can include the following functionality: when a user posts an Internet address associated with a commercial site, the system can generate a query to the administrator of the commercial site to determine whether the commercial site will become a sponsor. An indication that a commercial site is a sponsor can be indicated to users. In return for sponsorship, a board and/or searches and/or links relating to a commercial sponsor can be provided. For example, were a user to make a bulletin board referring to Languedoc-Roussillon, which may further include sub-topics topics such as gites, eateries, walks, tours, and entertainment, a link to an Internet postings to Festival Musica Carcassone, http://www.carcassonne-tourisme.com/carcassonne_SP.nsf/vueTitre/docVisiterFestival, may be posted by a user. When this commercial link is posted, a query to the commercial site may be generated to determine whether a sponsorship can be established. In this way, the commercial entity can provide updated information to the system, and/or it can be extracted on behalf of the commercial entity for availability to the users, for a fee.

The social media aspect of the platform invention includes the ability to connect with like-minded users. Offers to connect, the ability to form alliances, and ultimately organize offline meetings based upon shared interests are possible. Of course, as other social media is intertwined, the present platform invention can be part of the larger web of social media. As an example of the social media aspect of the present inventive platform, consider the possibility that a plurality of users plan to be in Languedoc Roussillon at a given time, they may also plan to be at a concert at Cite du Carcassonne for the same show, information derived from ticket sales by a sponsor to users or by other means such as travel itinerary posted on a board, but in any case, as a result of like-mindedness associative features characterized in this platform. For example, the platform can include functionality that will provide coherent information such as a ticket purchase to give the users who may be strangers except for their shared topic interests, the opportunity to meet up for dinner prior to a show. In this way, the present inventive social media platform provides users a way to share with like-minded others discoveries of both online and offline information and experiences.

As mentioned, at least one billion people travel per year. Any number of user created topic boards (see disclosure below) can be associated with the millions of destinations that exist, broadly and narrowly. Users on their boards may post Internet addresses of tours, eateries, markets, shops, museums and events relating to a particular destination, broadly and narrowly, and their itineraries. The system may solicit sponsorship of posted commercial enterprises and offer services of varying types and degrees to those posted commercial enterprises, and may provide integration with e-commerce systems of the commercial enterprises as they pertain to boards of users having profiles on the system.

The term commercial entity or enterprises includes any entity capable of providing a service or product of any kind, including for free. E-commerce used in the context of this invention also includes activities in which money is not necessarily exchanged. For example, reservations and free admissions are contemplated as would be any other type of transaction, such as a bartering system which is used, for example in house-exchange entities. Therefore a commercial entity can be, for example, a not-for-profit, a charity, a government or non-government project. The term commercial entity is used for convenience and is not intended to limit the scope of the invention.

A user having a profile does not necessarily need to access a commercial entity website for a transaction via the website of the present platform. Means to track a user's Internet activities are well known, such as via cookies. If a user were to make a transaction on a website that is posted to a board associated with the user's profile, that information may be available to the system to carry out the methods as described herein as well as those that are contemplated with regard to the social media platform for user-reliant ordering of Internet-based websites and postings as described in the aforementioned previously filed provisional patent application.

A system and method for connecting users of a social media platform that includes electronic bulletin boards of the present invention can include, with respect to a particular profile and an associated electronic bulletin board having a post of a particular commercial entity, has the ability to determine a specific activity pursuant to the particular profile and relating to the particular commercial entity. Also, the present system and method, with respect to a different profile and a different associated electronic bulletin board having a post of the commercial entity, can also have the ability to determine a specific activity pursuant to the different profile and relating to the particular commercial entity. In particular it may be useful to determine if the specific activity pursuant to the particular profile and the specific activity pursuant to the different profile have an element in common. The element in common can be that the user's made a transaction for the same thing, such as a ticket to an event.

Also, in particular, it may be particularly relevant if the particular commercial entity has an e-commerce capability and so as to determine if the element in common of the activity pursuant to the particular profile and the different profile is an e-commerce element. For example, were two users having respective profiles to purchase tickets to enter the Sistine Chapel on a particular day, they may be pleased to receive a notification of there being an expectation of both users will be at the Sistine Chapel on the same day.

In another embodiment, the element in common may be a purchase of an item from an online vendor who is registered with the system. The vendor may sell any type of items or services, including digital media, downloadable and otherwise. Large vendors such as Amazon exist and have comments systems of their own. Oftentimes, people wonder if those comments are loaded for financial gain. In the present system, the satisfaction levels that may be noticed to users having profiles with boards including those websites, could be completely independent of the vendors own comments sections. Satisfactions levels may be in opinion formats or by itemized surveys. In this way, the system may further comprise the ability to generate a notification to at least one of the particular profile and the different profile of the satisfaction level of the specific activity when the particular profile and the different profile have an element in common, which may be a transaction with the posted commercial entity or consideration of a product or service for purchase. For small vendors who have limited reputations and limited web presences, this aspect of the present invention may be very useful. Satisfaction level notifications may be a commercial entity sponsorship aspect of the system.

The following discussed itinerary embodiment may be incorporated into the system, or even operate as a different system utilizing the same platform as add-on features to the platform system of the present invention. In any event, the access to the boards built by other users can assist users to generate itineraries that will ultimately allow them to connect with like-minded users who have posted pertinent information. For example, an embodiment of the present invention includes a method for connecting users who generate a first board associated with a first profile, the first board including elements of an itinerary and generate a second board associated with a second profile, the second board including elements of an itinerary. A determination can made whether the first board and the second board match in a particular way such by location. A determination can also be made regarding permission criteria of at least one of the first and second profiles to access at least one of the first and second profiles so that if it is permitted, the system provides access to at least one of the first and second profiles.

Itinerary planning can include many useful features. For example, boards can be accessed by icons on a map. As mentioned previously, boards can be created or built by individuals, groups or entities. Therefore, a board consistent with a particular region may include any information. So for example, if a user were planning a trip to Languedoc-Roussillon, Carcassonne would most like be in view of the user either on a map of the present system, or on any map of the region. Users may have posted the link to, http://www.carcassonne-tourisme.com/carcassonne_SP.nsf/vueTitre/docVisiterFestival on their boards associated with region. In fact, Festival Musica Carcassone may create and maintain its own board, listing links based on dates of shows, since its schedule is extensive. Moreover, Festival Musica Carcassone may be a sponsor, so that various functionalities including tying dates of events to a user's itinerary, that is, presenting the user with options and thus helping to plan a trip may be extremely useful to users. Many tie-ins for sponsors listed on boards that are described herein as well as others that are contemplated, can be incorporated into the system and can be beneficial to both users and sponsors.

If a road (or canal or river for that matter) to travel upon is selected, which can be a small or large road, boards having Internet related posts regarding features of the route such as eateries, shops and sights, can be displayed. The benefit of the boards will be that the information is user-reliant, and if an itinerary planner finds that the boards of a particular profile are reliably good, they may limit the boards for review to those they find particularly useful.

In a different way to access information, there may be an option to select boards based on sponsor information such as criteria including the types of enterprises. This may be a particular benefit of becoming a sponsor so that the system can parse through topics based on board's content, verses a board's user-assigned topic. For example, if a sponsor were an art gallery, boards containing galleries including at least one with sponsored gallery (if there were sponsors in that region) would be listed for the user's consideration. If a sponsor were an independent three-star Michelin rated restaurant, boards containing sponsored restaurants of that type would be listed, or possibly prioritized. If a sponsor were an historical or Heritage Site, boards containing that type of sponsored place would be listed. Of course, in so doing, sponsor and non-sponsor entities can both be displayed, allowing smaller entities to be discovered. A user may opt out of prioritization, and in fact receive boards that include no sponsors' websites. Optionally, a user may request that sponsorship is not shown, or may be turned on or off at the user's discretion.

It may be useful to time the information provided in boards, so that the data does not become out dated. Requests to users having profiles to confirm information on their boards may be useful. Were a board unmaintained for a predetermined period of time, measures may be taken to delete it.

The present invention is an alternative to search engines and current social media by allowing users to share little known information, and promote small businesses, events, and information in a coherent manner. Commercial entities can benefit from the word-of-mouth, topic-based information dissemination by regular folks. Commercial entities as sponsors can promote connections based on their sales via the present platform. In this way, the present inventive social media platform can cross boundaries and penetrate a variety of market paradigms previously untouched by digital technologies.

As mentioned, at least one billion people travel per year. Any number of user created topic boards (see disclosure below) can be associated with the millions of destinations that exist, broadly and narrowly. Users on their boards may post Internet addresses of tours, eateries, markets, shops, museums and events relating to a particular destination, broadly and narrowly, and their itineraries. The system may solicit sponsorship of posted commercial enterprises and offer services of varying types and degrees to those posted commercial enterprises, and may provide integration with e-commerce systems of the commercial enterprises as they pertain to boards of users having profiles on the system.

The term commercial entity or enterprises includes any entity capable of providing a service or product of any kind, including for free. E-commerce used in the context of this invention also includes activities in which money is not necessarily exchanged. For example, reservations and free admissions are contemplated as would be any other type of transaction, such as a bartering system which is used, for example in house-exchange entities. Therefore a commercial entity can be, for example, a not-for-profit, a charity, a government or non-government project. The term commercial entity is used for convenience and is not intended to limit the scope of the invention.

A user having a profile does not necessarily need to access a commercial entity website for a transaction via the website of the present platform. Means to track a user's Internet activities are well known, such as via cookies. If a user were to make a transaction on a website that is posted to a board associated with the user's profile, that information may be available to the system to carry out the methods as described herein as well as those that are contemplated with regard to the social media platform for user-reliant ordering of Internet-based websites and postings as described in the aforementioned previously filed provisional patent application.

A system and method for connecting users of a social media platform that includes electronic bulletin boards of the present invention can include, with respect to a particular profile and an associated electronic bulletin board having a post of a particular commercial entity, has the ability to determine a specific activity pursuant to the particular profile and relating to the particular commercial entity. Also, the present system and method, with respect to a different profile and a different associated electronic bulletin board having a post of the commercial entity, can also have the ability to determine a specific activity pursuant to the different profile and relating to the particular commercial entity. In particular it may be useful to determine if the specific activity pursuant to the particular profile and the specific activity pursuant to the different profile have an element in common. The element in common can be that the user's made a transaction for the same thing, such as a ticket to an event.

Also, in particular, it may be particularly relevant if the particular commercial entity has an e-commerce capability and so as to determine if the element in common of the activity pursuant to the particular profile and the different profile is an e-commerce element. For example, were two users having respective profiles to purchase tickets to enter the Sistine Chapel on a particular day, they may be pleased to receive a notification of there being an expectation of both users will be at the Sistine Chapel on the same day.

In another embodiment, the element in common may be a purchase of an item from an online vendor who is registered with the system. The vendor may sell any type of items or services, including digital media, downloadable and otherwise. Large vendors such as Amazon exist and have comments systems of their own. Oftentimes, people wonder if those comments are loaded for financial gain. In the present system, the satisfaction levels that may be noticed to users having profiles with boards including those websites, could be completely independent of the vendors own comments sections. Satisfactions levels may be in opinion formats or by itemized surveys. In this way, the system may further comprise the ability to generate a notification to at least one of the particular profile and the different profile of the satisfaction level of the specific activity when the particular profile and the different profile have an element in common, which may be a transaction with the posted commercial entity or consideration of a product or service for purchase. For small vendors who have limited reputations and limited web presences, this aspect of the present invention may be very useful. Satisfaction level notifications may be a commercial entity sponsorship aspect of the system.

The following discussed itinerary embodiment may be incorporated into the system, or even operate as a different system utilizing the same platform as add-on features to the platform system of the present invention. In any event, the access to the boards built by other users can assist users to generate itineraries that will ultimately allow them to connect with like-minded users who have posted pertinent information. For example, an embodiment of the present invention includes a method for connecting users who generate a first board associated with a first profile, the first board including elements of an itinerary and generate a second board associated with a second profile, the second board including elements of an itinerary. A determination can made whether the first board and the second board match in a particular way such by location. A determination can also be made regarding permission criteria of at least one of the first and second profiles to access at least one of the first and second profiles so that if it is permitted, the system provides access to at least one of the first and second profiles.

Itinerary planning can include many useful features. For example, boards can be accessed by icons on a map. As mentioned previously, boards can be created or built by individuals, groups or entities. Therefore, a board consistent with a particular region may include any information. So for example, if a user were planning a trip to Languedoc-Roussillon, Carcassonne would most like be in view of the user either on a map of the present system, or on any map of the region. Users may have posted the link to, http://www.carcassonne-tourisme.com/carcassonne_SP.nsf/vueTitre/docVisiterFestival on their boards associated with region. In fact, Festival Musica Carcassone may create and maintain its own board, listing links based on dates of shows, since its schedule is extensive. Moreover, Festival Musica Carcassone may be a sponsor, so that various functionalities including tying dates of events to a user's itinerary, that is, presenting the user with options and thus helping to plan a trip may be extremely useful to users. Many tie-ins for sponsors listed on boards that are described herein as well as others that are contemplated, can be incorporated into the system and can be beneficial to both users and sponsors.

If a road (or canal or river for that matter) to travel upon is selected, which can be a small or large road, boards having Internet related posts regarding features of the route such as eateries, shops and sights, can be displayed. The benefit of the boards will be that the information is user-reliant, and if an itinerary planner finds that the boards of a particular profile are reliably good, they may limit the boards for review to those they find particularly useful.

In a different way to access information, there may be an option to select boards based on sponsor information such as criteria including the types of enterprises. This may be a particular benefit of becoming a sponsor so that the system can parse through topics based on board's content, verses a board's user-assigned topic. For example, if a sponsor were an art gallery, boards containing galleries including at least one with sponsored gallery (if there were sponsors in that region) would be listed for the user's consideration. If a sponsor were an independent three-star Michelin rated restaurant, boards containing sponsored restaurants of that type would be listed, or possibly prioritized. If a sponsor were an historical or Heritage Site, boards containing that type of sponsored place would be listed. Of course, in so doing, sponsor and non-sponsor entities can both be displayed, allowing smaller entities to be discovered. A user may opt out of prioritization, and in fact receive boards that include no sponsors' websites. Optionally, a user may request that sponsorship is not shown, or may be turned on or off at the user's discretion.

It may be useful to time the information provided in boards, so that the data does not become out dated. Requests to users having profiles to confirm information on their boards may be useful. Were a board unmaintained for a predetermined period of time, measures may be taken to delete it.

The present invention is an alternative to search engines and current social media by allowing users to share little known information, and promote small businesses, events, and information in a coherent manner. Commercial entities can benefit from the word-of-mouth, topic-based information dissemination by regular folks. Commercial entities as sponsors can promote connections based on their sales via the present platform. In this way, the present inventive social media platform can cross boundaries and penetrate a variety of market paradigms previously untouched by digital technologies.

The present invention is not limited by what is disclosed herein. There are some natural evolutions of the embodiments presented. For example, were a searching user to pick a location, such as Canberra, and then pick a topic to search for boards, and there were none found, the system may broaden the regional search results without prompting or with prompting.

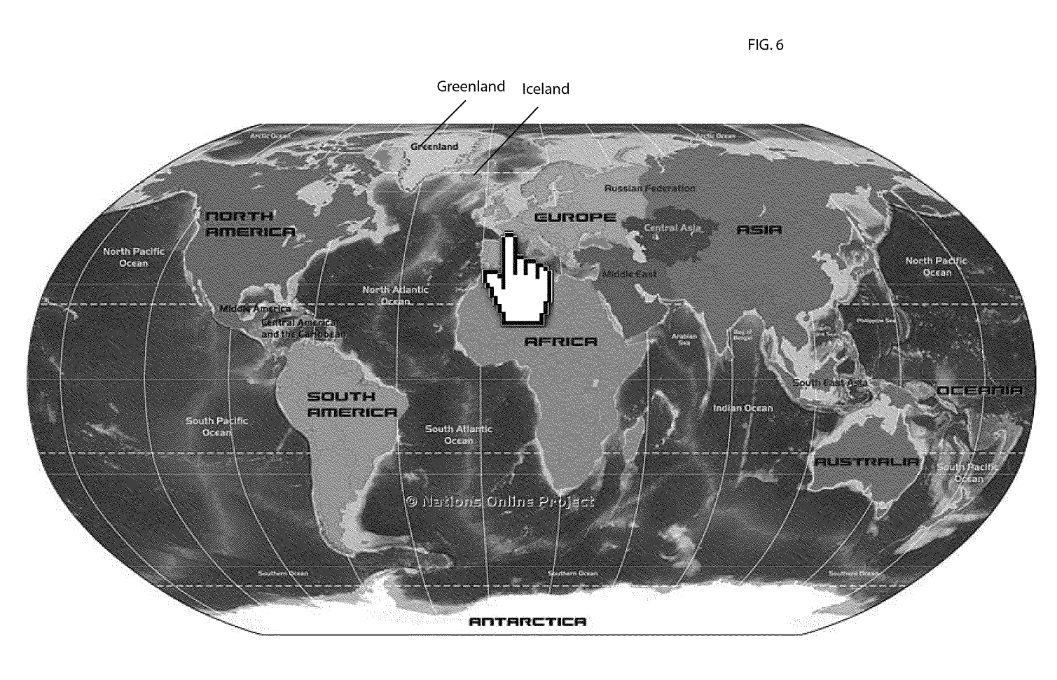

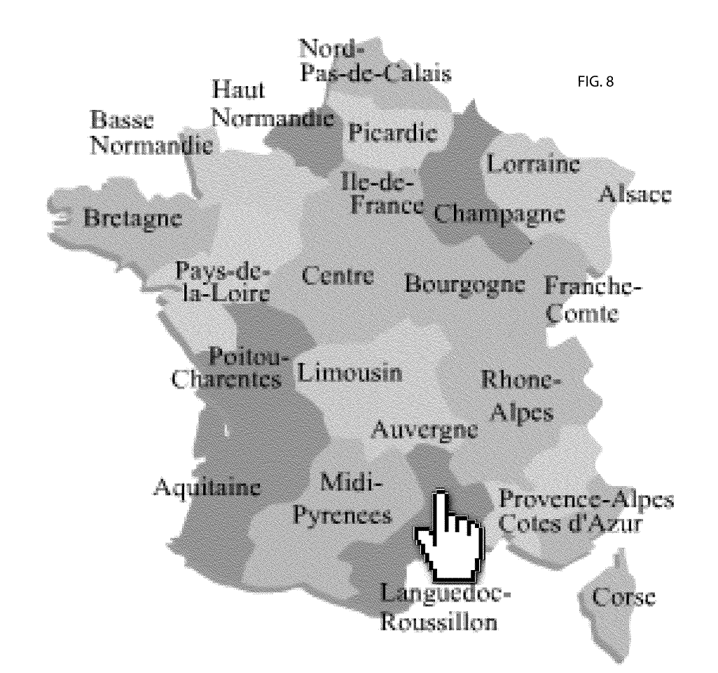

FIG. 6 illustrates a map of the world with a finger selecting a region of the world, in this case Europe and FIG. 8 illustrates a map of France with a finger selecting a region of France, in this case Languedoc-Roussillon. The map/finger depiction is a good way to select a region for either a board building user or a searching user.

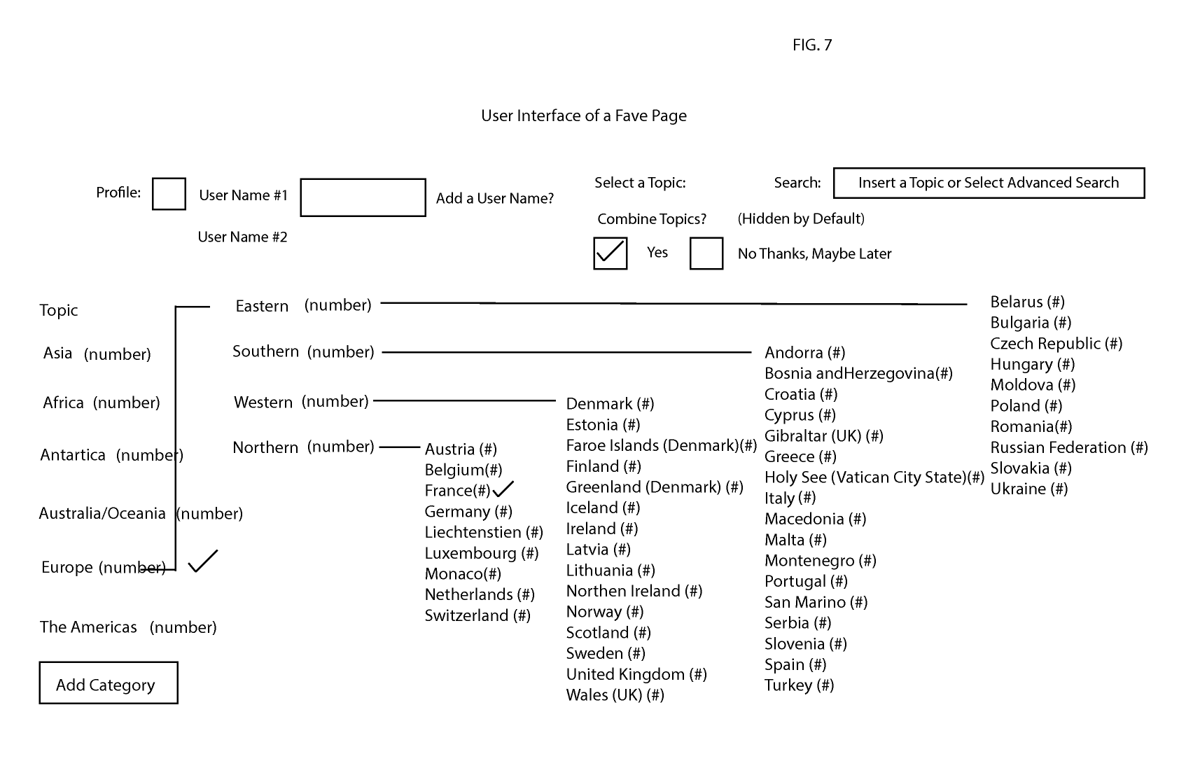

FIG. 7 illustrates a topic page listing the region selected in FIG. 1, Europe as well as subregions, Eastern, Southern, Western and Northern and the countries in each of these. France has been selected. The topic listing page of this FIG. 2 could have been provided in a map form in a similar way as FIGS. 1 and 3. In any event, selecting a region may make the utilization of the system region specific. While other non-region specific uses of the system, than that of global local information, such as social media based upon interests as previously discussed, user interfaces may or may not necessarily include map/finger depictions or region categorizations.

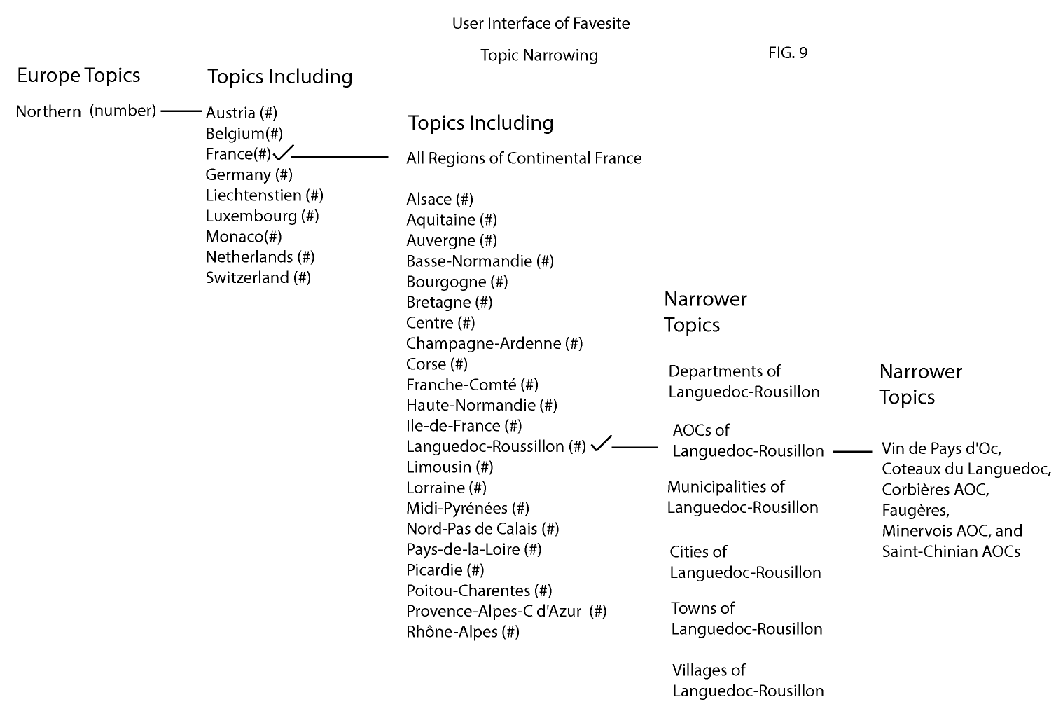

FIG. 9 illustrates a topic page listing of the Languedoc-Roussillon region including a break-down of different region characteristics that may assist a traveller determine an itinerary, where it is understood that all sovereign states have region characteristics that can be broken down in different ways and that this depiction of the manner France is broken down does not limit the scope of the invention. There may be opportunities to correlate information on boards based on regions. For example, harvest times for wineries may be of interest to some searching users. Other criteria such as time, season, weather and/or event based information may also be factored into the initial searching criteria of a searching user or a board building user. It is understood that various functionality can included to suit the system.

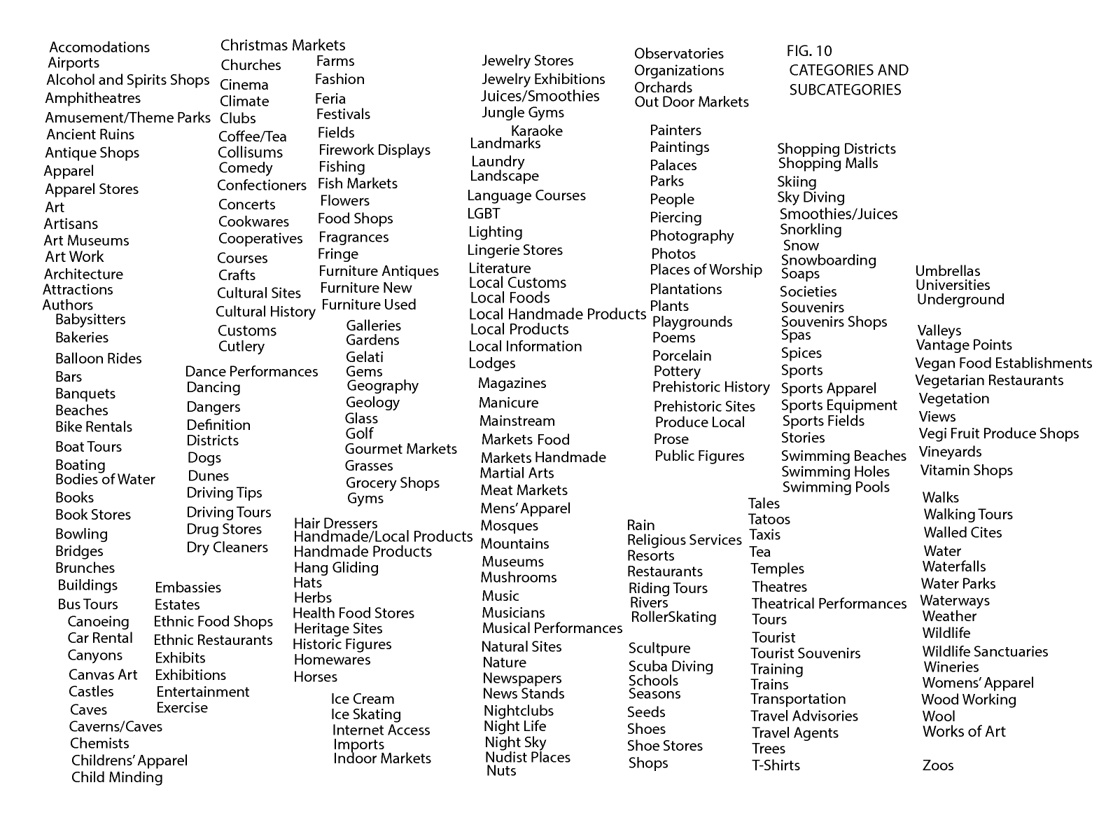

FIG. 10 depicts alphabetical topic lists of items that may be of interest to a traveller looking for local information where it is understood that this list depiction is an example of what a list may look like for the Languedoc-Roussillon region of France, and that all sovereign states have regional characteristics that may lend themselves to different categorizations and subcategorizations. The categories and subcategories may be customized to the region selected. This can be done by monitoring additional categories added by users or any other suitable manner. Categories can also be determined in any number of manners, such as using categories of local telephone books that may appeal to travellers, in particular.

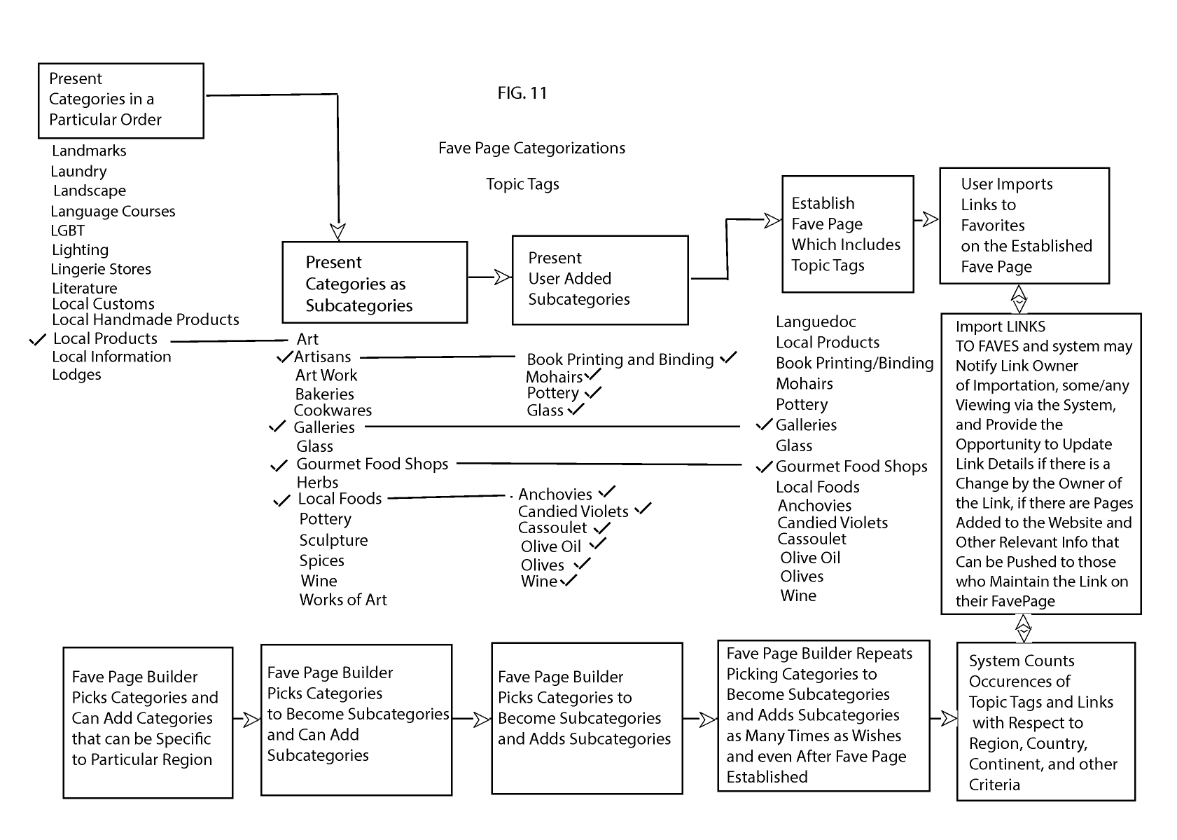

FIG. 11 depicts an embodiment of the manner in which a board can be constructed by a user adding to the system. For example, a builder may start with respect to the region selected via the topic listing page of FIG. 10, and then move to FIG. 11, where the clicking on “local products” may present categories and subcategories, where further indicating by clicking or highlighting or any other suitable manner, may present the topics including categories and subcategories, with distinction or not between them. The board/fave page is presented and the user imports links to the board and the system crunches the data including counting occurrences of topic tags and links When there is an import a links of a Faye to a Favepage, the system may Notify the Link Owner of the Importation, any Viewing via the System and/or outside the system, any pushes of the link that occur, and provide the opportunity to Update Link Details if there is a Change by the Owner of the Link such as a new domain name in an effort that links stay current, if there are Items or Pages Added to the Website and Other Relevant Info that Can be Pushed to those who Maintain the Link on their FavePage. A feature of the social media platform may be the constant checking, updating and pushing of posted Links to Faves for a plethora of reasons, some of which are described herein and including providing a user experience to promote continued use and sponsorship of the system by those who benefit from it, and who wish to benefit from it more.

As mentioned above, it may be a best practice to limit the number of topics per page, possibly according to their standing as a category and/or subcategory. An owner of a gourmet food shop may add a link to his own gourmet food shop on his board, but then may know others in the business that he would recommend, for possibly different lines of products. Combining too many categories on a board, may make the board move to the bottom of the search result of boards. However, where there is only one board presented, as may be the case of a small village in a remote location, the practice of adding many categories and subcategories may entice travellers to visit that particular remote village where they would otherwise not pull off the main highway to do so. In this way, users may decide how they wish to use the system. They may use it in more than one way.

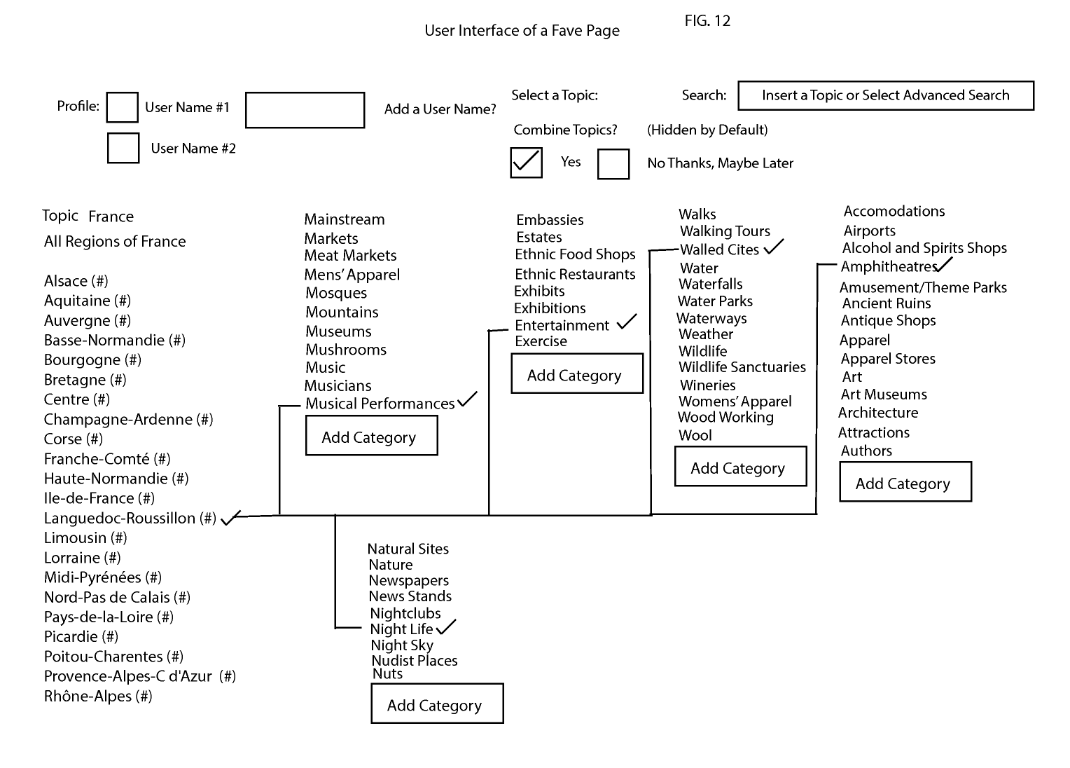

FIG. 12 depicts an embodiment of the manner in which a user can search the system. Again referring to FIG. 10 where Languedoc-Roussillon is selected, a user may make selections for musical performances, entertainment, walled cites, amphitheatres, and nightlife, the lists similar to those found on FIG. 12. As mentioned, one or more date filters may be provided to provide the searching user the opportunity to limit their search to relevant information such as entertainment that will be presented during the time that they plan to be in a particular area, as well as the types of entertainment they would enjoy the most. Entertainment can include festivals where entertainment is presented as part of the whole experience as well. When searching events, the system can prompt whether to include surrounding regions or automatically include them. When dates are presented for searching criteria, providing dates can help plan a searching user's itinerary.

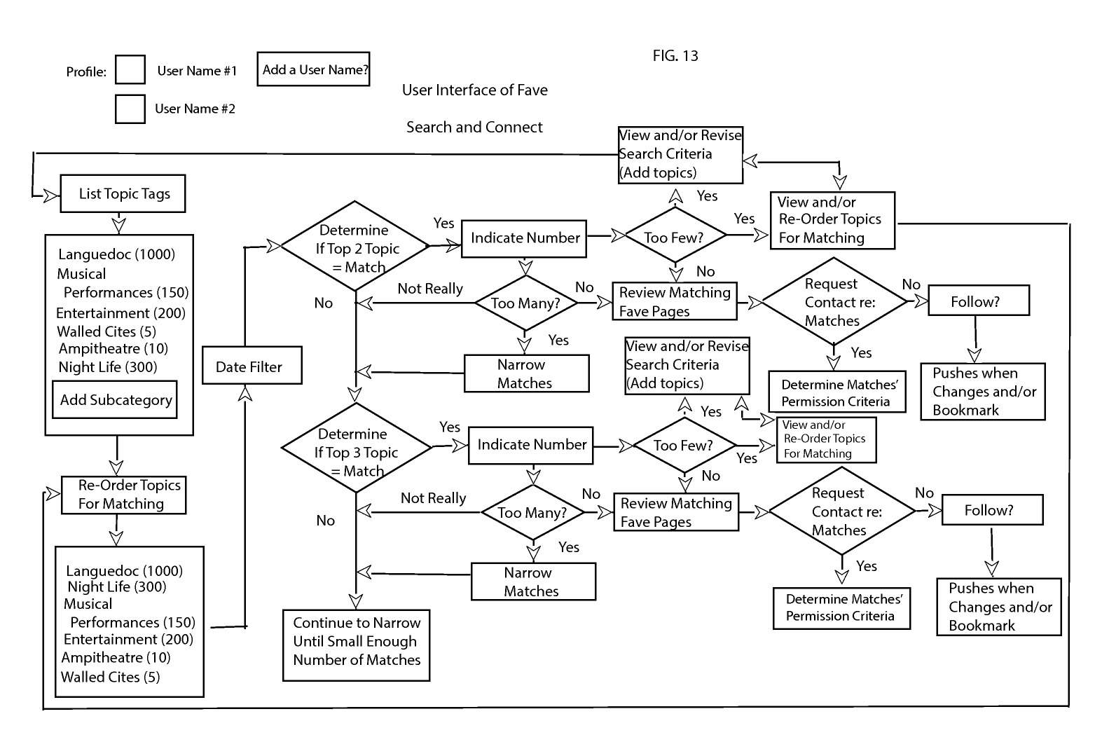

FIG. 13 depicts an embodiment of the manner in which a user can search the system based on the selected topic tags of FIG. 12 and find boards/fave pages of other users and have the potential to connect with those users. In the case of entertainment in particular, a date filter may be useful. However, when a link to an attraction or a festival is presented, then it may be beneficial to determine if the information presented is reloaded so that old information is not cached.

The system, in an effort to make searches of boards posted by users most productive may include the method steps of ordering the plurality of topic terms according to a rating criteria to generate a first set of rated topic terms to form a first search criteria, executing a first search according to the first search criteria to generate a first search result, determining whether the first search result provides too many search results or too few many search results, and if there are too many search results, selecting a second set of the rated topic terms to form a second combined topic search criteria either by adding a topic previously selected by the user but not used to form the first search or by reordering the topics selected by the user to form a new search, or if there are too few search results, indicate topic terms so that one or more topic terms may be selected by a user to form a new search. As discussed previously, there is an opportunity to connect with other users of the system. The social media aspect of the invention can promote relationships and commerce.

Still referring to FIG. 13, the system and method may include at least some of the following features: that a plurality of topic terms correlated with occurrences within the system which may be selected by a user, rating the occurrences of the topic terms within the system to reorder them according to the rating, selecting the highest rated occurrences of topic terms, determining whether a first combination of the highest rated occurrences yields a result, if the first combination of the highest rated occurrences yields a result, determine whether there are too many results or too few results, if there are too many results, select the next or too few results, revise the search, wherein the rating correlates to their occurrences within the system, the highest rated occurrences yields a result, if the first combination of the highest rated occurrences yields a result, determine whether there are too many results or too few results, if there are too many results, select the next, or too few results, wherein the first combination of topic terms is the highest rated occurrences yields a result, rating is number of occurrences within the system, criteria is occurrences within the system, reorder manually or by the system, if there are too many, selecting a second set of the rated topic terms to form a combined topic search criteria—add a topic term.

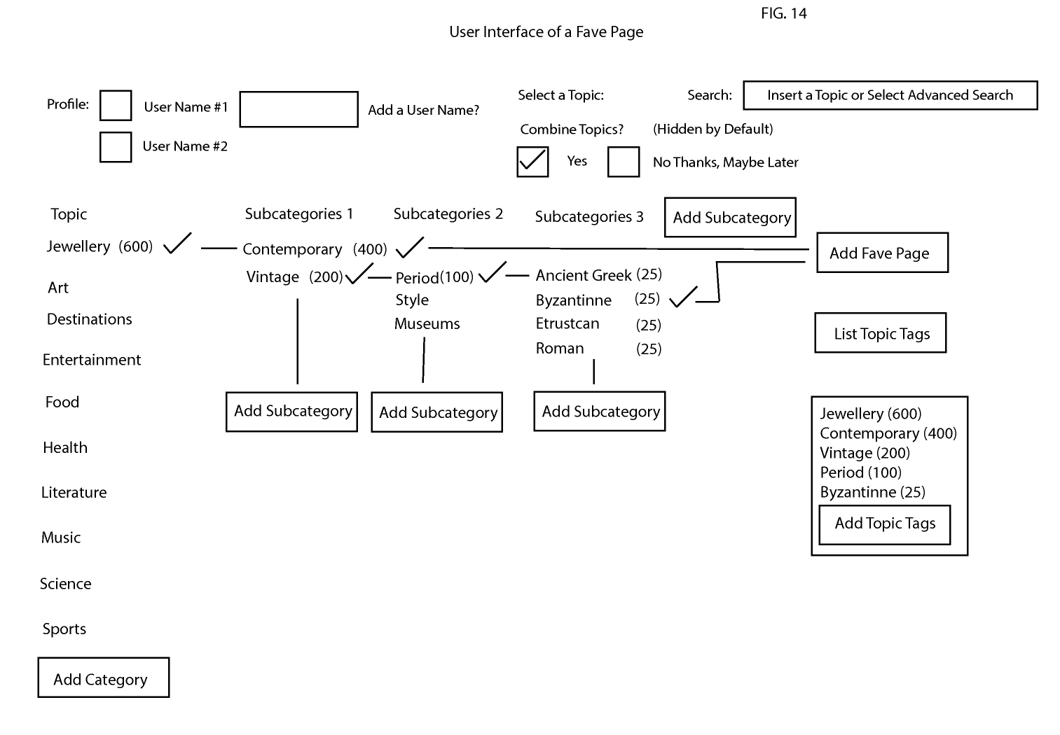

FIG. 14 depicts an embodiment of the manner in which a board can be constructed by a user adding to the system in which general topics are presented. In this case, where a user is a jewellery enthusiast, in a manner similar to that of FIG. 11, can construct a board/fave page;

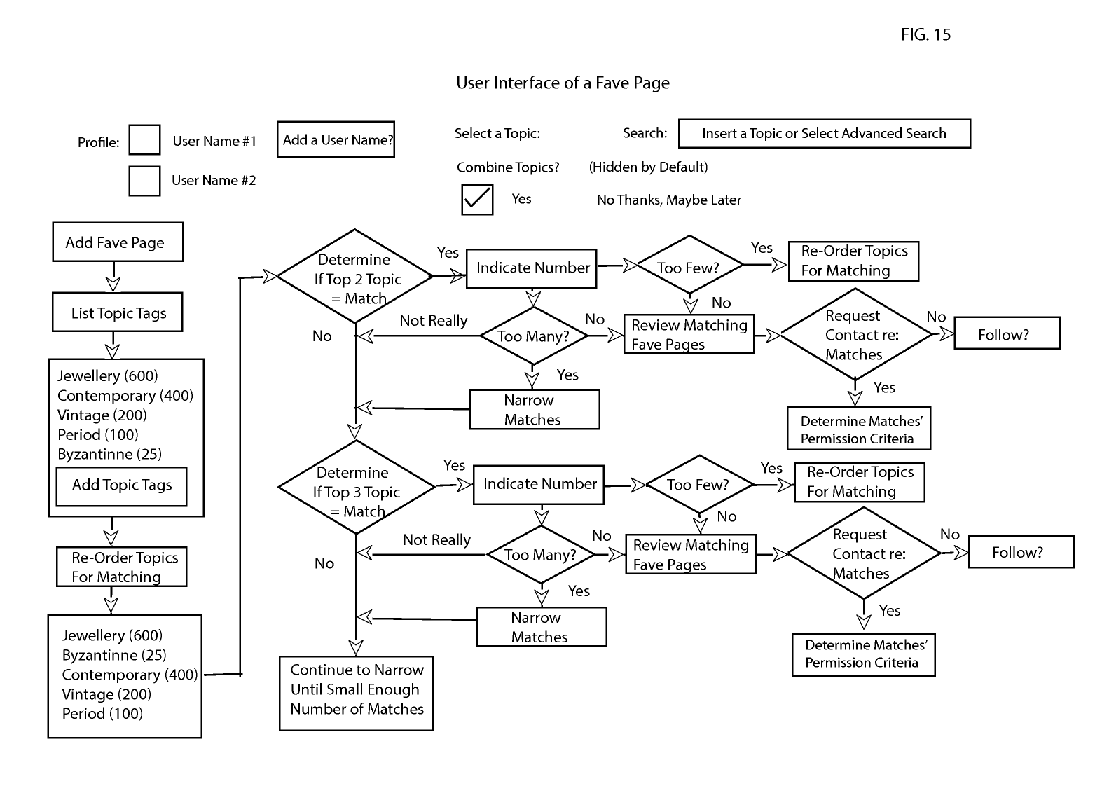

FIG. 15 depicts an embodiment of the manner in which a user can search the system based on the selected tags of FIG. 14 and find boards/fave pages of other users and have the potential to connect with those users.

In the situation where a user has set up one or more boards or fave pages to provide their own promotion, that is, which may not be avoided, it may be determined that there is only one link on the page. In this way, it is also relevant to determine how many links are on the page, as well as to distinguish the links, that is to determine whether there are links to the same website, but simply different pages on that website. For example if there is are the following links, such as www.momandpopsplace.com/index, and www.momandpopsplace.com/menu, and wwww.momandpopsplace/contact, it can be determined that these three links are to the same website and that there is only one website on the board/fave page. While it can be a purpose of the system to give exposure to Mom and Pop's Place, they would be better served to add more distinct links to promote more entities. Therefore, analysis of each board for the number of distinct links posted thereon can be a ranking feature of the system. Mom and Pop's extended family may have an extended family and links to their family's websites may also be posted which may or may not yield any useful information to those system users that find Mom and Pop's self-serving postings on their board. A determination of whether a user finds the board/fave page useful that is, it promotes knowledge building can be ranked, then there may be a way in which to track its usefulness.

One manner in which to track a board/fave page's usefulness may be the number of follows or so called bookmarking of the page. Also, the number of “requests for contact” may provide an indication of the board/fave page's usefulness. In the example above, where www.momandpopsplace.com is self-servingly posted by Mom and Pop and the other links are to entities that would not interest a traveller, such as to the township baseball league, or the local hardware store, then will soon become known that the board/fave page is self serving.

On the other hand, since Mom and Pop are locals of their community, they can, in all honesty, promote their favourite local businesses such as a dress shop, a hair dresser and a jewellery shop. It may also be that those businesses will likewise set up their own boards and list each other as a sort of conspiracy to get noticed, as do businesses adjust their web offerings and behaviour for searching on search engines. In this situation it may be that the system will check for boards/fave pages that are substantially similar to each other and rank their usefulness accordingly. When the number of boards/fave pages is high (too many?) as is the case as illustrated in FIGS. 13 and 15, boards having substantially the same links on them may be grouped and may be presented last. When there are few (too few?) board/fave pages, as illustrated in FIGS. 13 and 15, the user of the system may view the boards/fave pages to determine their usefulness before either re-ordering their search criteria and/or revising their search criteria, for example, to add topic categories and/or subcategories. The system can track a user's viewing behaviour of viewing the boards/fave pages presented to the user upon their search of the system. If when only a few boards are presented, and the user looks at only a few of the few, the system may be able to determine that the boards presented together at this time are too similar and that obviously the system was loaded by self-serving interests. An alert may be indicated to the user who stumbles upon the too similar boards that the array of boards are suspect.

There is substantial evidence that ratings are loaded. For example, book reviews on Amazon have been found to be authored by the book's very author. One aspect of this invention will uncover loading boards for self-interest.

Measures may be taken include when it is determined that there is self-serving loading of boards/fave pages, a notice may be sent to the owner of the user profile of the board inquiring about the suspect system abuse. Therefore, during the construction of boards/fave pages, it may be a good practice to alert the owner of the user profile that self-serving loading of the system can be detected, and therefore, it is unwise to collaborate with others in an attempt to try to over utilize the system for self-interest. It would be better to collaborate in a single board/fave page as a cooperative than to load the system many boards having the same or very similar information, innumerable times.

To promote better use of the system, best practices can be promoted and measures can be taken. For example the fewer topic categories or subcategories associated with a board, the better chance that it will be viewed. For example, a town may have many antique shops. If the antique shops of the town collaborated together and added links of the antique dealers in the town on the same page, a user of the system who is looking for antiques may very well find the board/fave page with the antique dealers and specifically go to that town during their travels.

Another potential benefit of the social media aspect of the present invention is that those seeking local information for other purposes than travelling, that information can be found. For example, if the present author were to wish to form a guild, where one is not currently formed, say, jewellery artists in the ACT and surrounding area, finding those other jewellery artists would be more possible than if traditional word-of-mouth is the only method, since traditional search engines cannot provide this type of information. Or, were an enterprise such as a business directory listing local businesses of certain types, those could be found more easily in accordance with the presently disclosed systems and methods than any other currently available method. Many other benefits, too many to list, are possible.

It is understood that the terms used in this disclosure may include fanciful terms that the author will or has already filed trademark registration applications on. Other terms, such as website address, or distinct domain include all terms of art including a uniform resource locator (URL) (originally called universal resource locator) is a specific character string that constitutes a reference to an Internet resource.

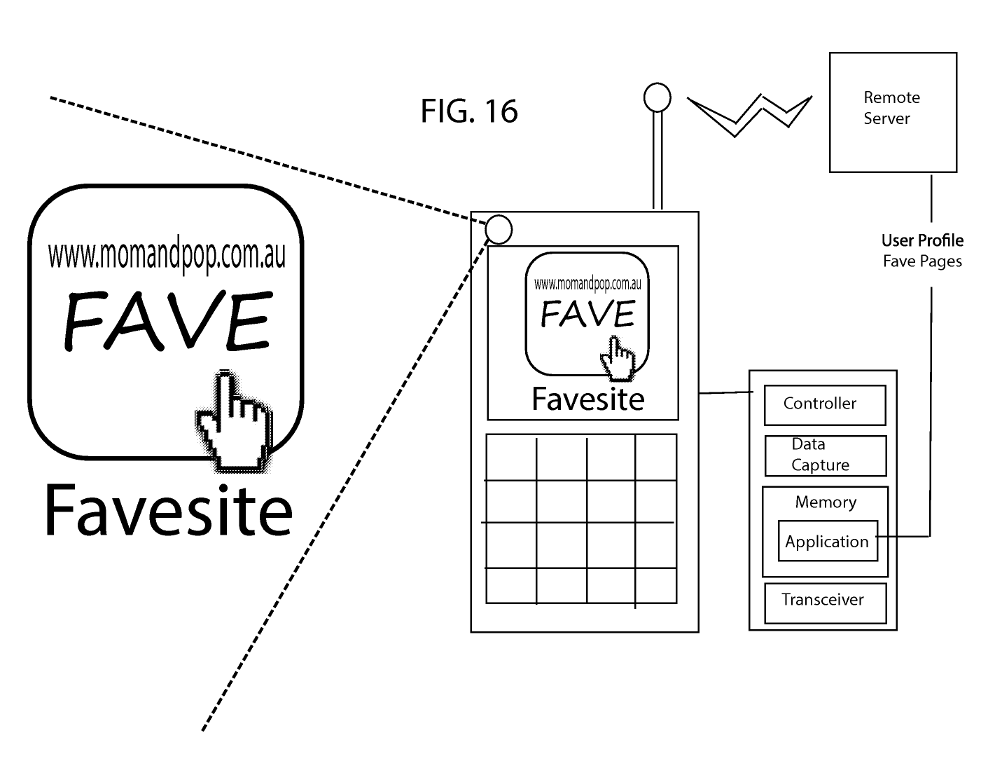

FIG. 16 depicts a mobile device capturing a signal or an image of printed media that includes an Internet address of an entity. The printed media here shown as a FAVE button can be a placard. The FAVE button is not required of course, but does act to remind a user to use the service, assuming that the user has established a user profile with FAVE, potentially a plurality of pages, and the mobile device includes a mobile application of FAVE.

An Internet address can be printed on a sign, a flyer, business card, or any other type of printed media. The media can be digital such as digital signage or any other type of media such as graffiti or sky writing. If no media is available, then as alluded to above, a user can write on a piece of paper or in the sand, or any other media, the name of the entity that the user wishes to add to their page associated with their user profile, and take a picture or video of that. The application in communication with the engine may determine the location of the entity and therefrom, determine the Internet address of that entity. It may be that the Internet address is a Yellow Pages listing. That is discussed in the appended applications. If the entity's Internet address is not determined by the system, the system may alert the user. Or if there is a discrepancy where two or more Internet addresses are similar, the system may query for a decision by the user.

The term entity can mean a subcategory such as a department store having different departments, such as shoes and jewellery. The entity can be small or large, and can include any number of subcategories. The user may provide positive data about an entity and can refine that at any time. For example, if an entity separates their website into different categories, their website address will contain an extension. An extension can be determined in any number of ways, and any positive data can be refined upon capture of at any time thereafter. For example, were a user to take a photo of a dress, and then handwrite the name of the entity that sells that dress on a piece of paper, and photograph that, the combination of images may be provided to the engine so that the engine may be able to determine the extension to find that dress on the entities website, and then post that item to the user's FavePage in the form of an Internet Address link. Of course, a photo of the item taken by the user or provided by the entity can be displayed on the FavePage along with the link. The manner of display of the positive data on the user's FavePage can be in a cascading arrangement, popular these days, or any other suitable arrangement and with any information that the user wishes to determine or contribute. An entity may, for example, position FAVE placards all over their store that provide the Internet address with any extension so that a user may capture the positive data and the engine may process the positive data.

The mobile device can include any type of signal, image or data capture component or peripheral or accessory such as a camera, Bluetooth, wifi, a wire connector that physically connects the mobile device to another device, an RFID tag reader, to name a few. For example, most mobile devices that are used as communication devices do not come with an RFID tag reader. However, in the industry literature, there has been talk of doing so. Accessories are available. Were the printed or other type of media to incorporate an RFID tag either thereon, or in relatively close proximity, or in a place that would be readable by the mobile device, the signal of the RFID could incorporate an Internet address. In another example, a user may be using a public computer but does not wish to access their account on the public computer. A photo of the screen of a computer including an Internet website may provide enough information to establish the positive data for use by the engine. The possibilities for data capture are numerous. In this way, the mobile device would be able to capture the positive data of an entity's Internet address. The application of the mobile device could process the positive data so that it is transmitted to a remote server that is in communication with the engine that will make that positive data in the form of an Internet address sharable and searchable. A local user being able to easily upload favourites by their mobile devices, for example, by QR codes provided by the vendor, to their favourites lists could make this information readily available to locals and travellers.

Whether the application of the mobile device or the engine at a remote server or in a cloud performs the functions of associating the positive data with a page of user profile is not relevant. The functions are to be performed at some point along the way. The issue is the capture of the positive data, the determination of an Internet address associated therewith and the correlation to a user profile so that the positive data in the form of an Internet address is sharable and searchable within the system. The mobile device will communicate the positive data in either its essential form or a transformed form. The essential form is for example, a signal of an RFID, an image captured including the Internet address, or an image captured that includes text of the entity's name or other identifying criteria. A transformed form would include an extrapolated Internet address recognized in an image of printed media, and/or a compiled Internet address determined from an image captured that includes text of the entity's name or other identifying criteria and associated with a location. As stated above, deriving the Internet address of a favourite can be performed by the mobile device and/or the engine of a remote location.

Other manners in which the data can be captured by the mobile device include a signal is received via WIFI, a signal is received via a cellular system, and where a signal is otherwise received wirelessly. The difference in the RFID scenario and the other manners just mentioned is that the application may need to query the user of the mobile device if a signal is received with no action taken by the user. A query by the application to actually identify the data as positive data and therefore to be correlated with the user profile would therefore be appropriate.

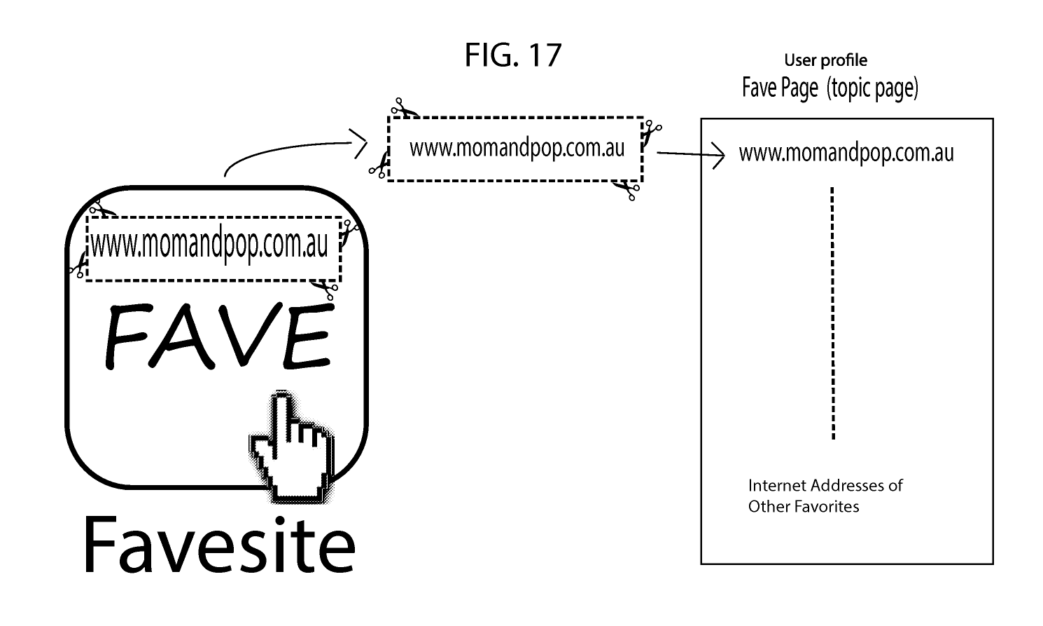

FIG. 17 depicts a process by which an Internet address can be processed by the application and/or the engine. An image capture may include the Internet address of the favourite entity or it may include its name. The image itself may be transmitted to the remote server or the image may be processed by the application of the mobile device. In any event, the text is recognized as shown in FIG. 17, and the relevant information, that is, the Internet address of the favourite entity is posted to the page associated with the user profile. On the other hand, if the Internet address is not provided in the image captured, but some other identifying characteristic of the entity, such as text that can be recognized and extrapolated may provide sufficient details to determine the Internet address associated with the positive data.

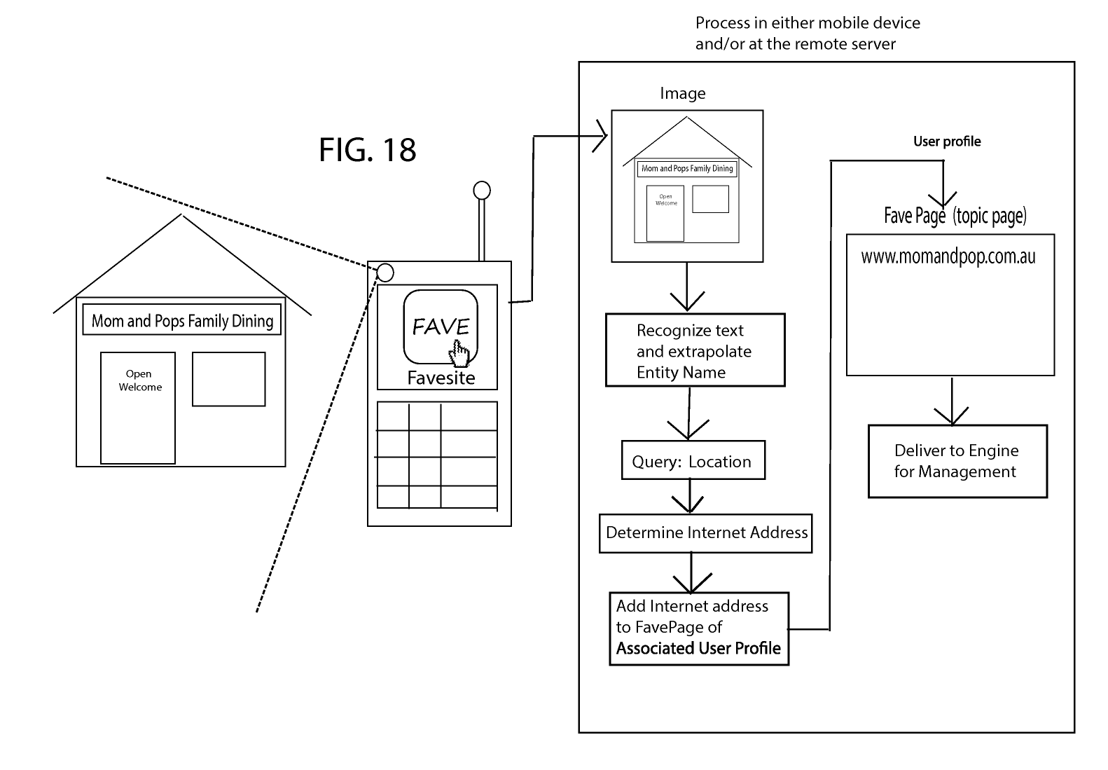

FIG. 18 depicts a process by which an image of an entity captured by a mobile device can be correlated with the Internet address of the entity and added to a page associated with a user profile. In this example, the mobile device captures an image of an entity wherein there is an identifying characteristic such as the text indicating the name of the establishment. The image is process to extrapolate the identifying characteristic. As mentioned any of these processes can be done by the application or at a remote server or cloud. If there is not sufficient information about the positive data, then one or more additional queries can occur, such as, a location query. The location query can be automatic such as a determination by GPS or simply the cellular system location of the mobile device, or the query can be directed to the user. In any event, the positive data can be correlated to an Internet address that is added to a page corresponding to the user profile of the mobile device user. Once that occurs, the combined information is delivered to the engine for management.

Management of the positive data not only makes a user's favourites shareable and searchable, it furthermore can allow users who share passions to connect. Sorting positive data into topics can be a user task, or the engine may be able to sort them. The engine may order the unordered collection of topics, separating them into categories, and if desired, different pages on behalf of the user or the user can organize them.

The engine can furthermore perform preference profiling, so that the data provided to users is based on the preference profile of that user's profile. For example, were a user to list on their page certain rock bands, for example, Jethro Tull, the Cranberries, GreenDay, and Todd Rundgren, then a music genre preference could be associated with this user, even if they did not list all of their favourites. For example, they may list only Andre Segovia who is unfortunately not with us anymore. However, other Spanish music guitarists may be of interest to the user when searching for an event during a specific time and place. That is, if the user to indicate an itinerary such as the user will be in Spain during the month of August, the engine can deliver to the user tour dates relevant to the user based on the preference genre of events occurring during that time while avoiding irrelevant information such as old web posts with expired information which is so common in retrieval based on SEO. Therefore, the engine can include web trawling capabilities as well to deliver to users information that they seek. For example, when using a search engine of Google, the data delivery includes information that is not sought, such as posts from previous events. Were a user interested in finding music events in Spain during a particular month, based upon the Internet address favourites posted on their page associated with their user profile, the web crawler of the present invention would look for dates that match their search request, avoiding expired information. Of course, a user may select all genres if it suits them. Referring to previous applications appended below, there is the ability to connect users with shared passions, that is, another user that will be in Spain during the same time period and has a preference for the same music genre. In this way, a user does not have to know where to look for the information on the Internet which is usually in the language of the country, in this case, in Spanish, Catalan or Basque.

A preference capability may be based on any number of criteria. For example, were a user to add positive data in the form of Internet addresses to specific confectioner stores that carry Belgian chocolates, the engine could determine that the user has a particular preference in shoes, perfume, and other items, and be able to make recommendations in topics that were not specifically posted by that user based upon the positive data associated with that user's profile.

The benefit of enabling users to add their favourites to their pages associated with their user profiles will enable the system to achieve substantial data in a short period of time. The application or another application of a mobile device can also provide the searchable and shared positive data to a user. For example, when a user is within the cellular reach of a particular area, information can be pushed to the user so that the user is apprised of favourites in the area. The information pushed can be filtered in any number of different manners. For example, the application can query the mobile user if the user wishes to receive certain information. The user can agree or not agree. The same would be true if a user enters an establishment that has a wifi or other wireless signal, where the user can be apprised of the positive data of the establishment provided in other users posts. Pages of other users can be made available, or any level of information the mobile user wishes to obtain. Moreover, itinerary information can be provided by the mobile user, and positive data in anticipation can be provided to a user. The application of a mobile device can provide some or all of the functions available on a computer as well as others.

It is understood that the terms used in this disclosure may include fanciful terms that the author will or has already filed trademark registration applications on. Other terms, such as website address, or distinct domain include all terms of art including a uniform resource locator (URL) (originally called universal resource locator) is a specific character string that constitutes a reference to an Internet resource.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

It is understood that the use of relational terms, if any, such as first and second, up and down, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

I claim:

1. A method for receiving and delivering Internet-related data, comprising:
receiving identifying information that is correlated to one or more user profiles;
receiving Internet-related data into a database, the data characterised by attributes, the data received via the input associated with one or more user profiles, wherein at least one attribute is geographical location data and another attribute is entity type and/or product type and/or event type data;
receiving a user notification that a device is capable of receiving geographic location data and entity type and/or product type and/or event type data;
correlating the attributes of the Internet-related data with a user profile and determining that the Internet-related data is prospective to generate matching data that is prospective, the matching data being defined by prospective characteristics if event type data;
delivering matching data output that is reconcilable on a user interface to indicate the geographical location data with respect to the entity type and/or product type and/or event type data with prospective characteristics;
making available, if available, a representation of the input associated with one or more user profiles from which the Internet-related data is derived taking into account prospective characteristics so that it is reconcilable on a user interface.

2. The method of claim 1, further comprising:
determining if a time element is associated with the Internet-related data;
if the time element of the Internet-related data does not provide prospective indications, submitting a query to the owner of the Internet-related data requesting prospective details; and
if it is determined that the Internet-related data is event type data and prospective details are not forthcoming or determinable from the Internet-related data itself, determining whether to publish the Internet-related data as output.

3. The method of claim 1, further comprising:
determining event type data from the Internet-related data.

4. The method of claim 1, further comprising:
associating a user profile with user preferences identifying specific event type preferences;
determining a geographical location preference associated with a user profile;
web trawling for Internet-related data associated with the identified specific event type data preferences to match event type data with a user profile to generated geographic event data; and
delivering geographic event data so that it is reconcilable by a user interface of a device.

5. A user interface, comprising:
means for delivering identifying information that is correlated to one or more user profiles via input of a device;
means for providing Internet-related data into a database, the data characterised by attributes, the data received via the input associated with one or more user profiles, wherein at least one attribute is geographical location data and another attribute is entity type and/or product type and/or event type;
means for delivering instructions to a remote server that a device is capable of receiving geographic location data and entity type and/or product type and/or event type data;
means for delivering communication with a remote server for correlating the attributes of the Internet-related data with a user profile and determining that the Internet-related data is prospective to generate matching data that is prospective, the matching data being defined by prospective characteristics;
means for delivering matching data output to indicate the geographical location data with respect to the entity type and/or product type and/or event type data with prospective characteristics if event type data;
means for making available, if available, a representation of the input of one or more users from which the Internet-related data is derived taking into account prospective characteristics.

6. The method of claim 5, further comprising:
means providing input to associating a user profile with user preferences identifying specific event type data preferences;
means for providing input for determining a geographical location preference associated with a user profile;
means for receiving data from a remote server, the data derived from web trawling for Internet-related data associated with the identified specific event type data preferences to match event type data with a user profile to generated geographic event data; and
means for representing geographic event data which reconcilable by a user interface of a device.

7. A method for determining prospective characteristics of Internet-related data, comprising:
receiving the Internet-related data, the data characterised by attributes, the data received via the input associated with one or more user profiles, wherein at least one attribute is geographical location data and another attribute is entity type and/or product type and/or event type data;
determining if a time element is associated with the Internet-related data;
if the time element of the Internet-related data does not provide prospective indications, submitting a query to an owner of the Internet-related data requesting prospective details;
if it is determined that the Internet-related data is event type data and prospective details are not forthcoming or determinable from the Internet-related data itself, determining whether to publish the Internet-related data as output; and
if available, making available a representation of the input associated with one or more user profiles from which at least some Internet-related data is derived taking into account prospective characteristics so that it is reconcilable on a user interface.

8. The method of claim 7, further comprising:
associating a user profile with user preferences identifying specific event type preferences;
determining a geographical location preference associated with a user profile;
web trawling for Internet-related data associated with the identified specific event type preferences to match prospective event type data and a geographical location preference with a user profile to generated geographic event data; and
delivering prospective geographic event data so that it is reconcilable by a user interface of a device.
